(19) United States
(12) Patent Application Publication
(10) Pub. No.: US 2011/0037427 A1
(43) Pub. Date: Feb. 17, 2011

(54) Plug And Play Battery System

(75) Inventors: Wayne Boncyk, Evergreen, CO (US); Gerald Murphy, Conifer, CO (US)

Correspondence Address: LATHROP & GAGE LLP, 4845 PEARL EAST CIRCLE, SUITE 201, BOULDER, CO, 80301, US

(73) Assignee: Design Net Engineering, LLC

(21) Appl. No.: 12/710,598

(22) Filed: Feb. 23, 2010

Related U.S. Application Data
(60) Provisional application No. 61/208,264, filed on Feb. 23, 2009.

(51) Int. Cl. H02J 7/00

(52) U.S. Cl. 320/107

(57) ABSTRACT

The present invention provides an energy storage device for spacecraft application. The energy storage device includes an energy storage component including a plurality of cells. Each cell has a minimum shelf life. The energy storage device also includes a first interface to an external power source configured for charging of the energy storage component, a second interface to a spacecraft for outputting power from the energy storage component and a third interface for communicating to spacecraft. The energy storage device further includes a charge controller operatively coupled with the energy storage component and the first, second and third interface. The charge controller includes an internal power supply configured to provide power for the charge controller. The charge controller also includes a microprocessor incorporating a firmware to accommodate a system configuration of the energy storage component.

### CROSS-REFERENCE TO RELATED APPLICATIONS

This application is a nonprovisional of, and claims the benefit of the filing date of U.S. Provisional Patent Application No. 61/208,264, filed Feb. 23, 2009, entitled “Plug and Play Battery”, the entire content of which is incorporated herein by reference.

### STATEMENT AS TO RIGHTS TO INVENTIONS MADE UNDER FEDERALLY SPONSORED RESEARCH AND DEVELOPMENT

The U.S. Government has rights in this invention pursuant to a grant by the Department of Defense Contract No. FA9453-08-C-0074 awarded by the U.S. Air Force.

### BACKGROUND OF THE INVENTION

Several Space Plug and Play Avionics standard (SPA) compliant avionics modules have been developed, including a Solar Array Controller and Energy Storage Modules (ESM) specifically tailored to support electrical power subsystems. SPA enables relatively fast configuration, integration, test, launch and deployment of space-based systems that are designed to support tactical operational needs of the war fighter in the field. One key requirement of the Operationally Responsive Space (ORS) Office at Kirtland Air Force Base with respect to spacecraft is to rapidly assemble and test spacecraft platforms from standard and depot-based components, potentially significantly reducing time for integration and test of traditional spacecraft from months to days.

Spacecraft typically need an electrical power generation and distribution subsystem for powering the various spacecraft subsystems. For the spacecraft in low earth orbit, solar panels are frequently used to generate electrical power. Spacecraft designed to operate in more distant locations, for example, Jupiter, might employ a radioisotope thermoelectric generator to generate electrical power. Electrical power may be sent through power conditioning equipment before it passes through a power distribution unit over an electrical bus to other spacecraft components. Batteries are typically connected to the bus via a battery charge regulator, and the batteries are used to provide electrical power during periods when primary power is not available, for example, when a low earth orbit spacecraft is eclipsed by the Earth or when high load conditions exist.

A lengthy process in the current art for developing spacecraft energy storage modules typically includes carefully selecting an energy storage device by specifying and sizing battery capacity and technology, such as lithium ion (Li-ion), nickel-cadmium (Ni—Cd) or other chemistry, to meet requirements of a particular spacecraft. The process may also include carefully designing a mission-unique charge control scheme that involves customized charge control hardware and firmware associated with the hardware for the selected energy storage device. Such a design process typically requires many months.

After the design process, specific batteries are built to meet the specifications for the particular spacecraft, which often adds more months to the process of developing an energy storage module. The specific requirements for each battery may include cell voltage, battery voltage, charge management, total energy storage, and peak current capabilities. Traditional batteries are customized to meet the requirements of vendor particular mission. Such requirements must be provided months before field deployment of a spacecraft. Currently, very few off-the-shelf power subsystem configurations are available for last-minute fitting to spacecraft. Such power subsystem configurations require considerably high cost to support maintenance and rotation of any batteries available for field deployment of the spacecraft. One issue with traditional spacecraft batteries is their limited shelf life, and requirements for careful maintenance and charge management from the time of assembly until launch. Nearly all current spacecraft batteries are inherently unable to satisfy ORS requirements, since they cannot be stationed at a depot in a flight-ready state for an extended period.

Furthermore, resources are needed to monitor battery charge status and cycles of charge and discharge to maintain battery performance between battery delivery and an actual flight. Hence, the current process requires a long waiting period for battery procurement and extensive resources required for maintenance of rechargeable cells. The current process also requires complicated procedures for integration of a battery into a Power Management And Distribution (PMAD) system design such that it takes a long time to assemble a power subsystem for the spacecraft.

### BRIEF SUMMARY

Embodiments of the invention pertain to techniques that allow Energy Storage Modules (ESM) to be built and stored ready for flight in a short lead time. More specifically, the ESM includes a battery, a SPA standard interface to spacecraft, and a controller having programmable firmware.

Embodiments of the invention provide an energy storage device for spacecraft application. The energy storage device includes an energy storage component including a plurality of cells. Each cell has a minimum shelf life. The energy storage device also includes a first interface to an external power source configured for charging of the energy storage component, a second interface to a spacecraft for outputting power from the energy storage component and a third interface for communicating to spacecraft. The energy storage device further includes a charge controller operatively coupled with the energy storage component and the first, second and third interface. The charge controller includes an internal power supply configured to provide power for the charge controller. The charge controller also includes a microprocessor incorporating a firmware to accommodate a system configuration of the energy storage component.

In additional embodiments of the invention, the charge controller further includes a relay module operatively coupled to the first and second interface and the energy storage component, and a power switching module operatively coupled to the energy storage component, the microprocessor, and the relay module.

In still more embodiments of the invention, the charge controller includes a conditioning module operatively coupled to the energy storage component, the internal power supply, and the microprocessor.

According to embodiments of the invention, the minimum shelf life of each of the plurality of cells is at least one year. In a preferred embodiment of the invention, the minimum shelf life of each of the plurality of cells is at least five years. In a particular embodiment, the third interface conforms to the Space Plug and Play Avionics network standard.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings.

### BRIEF DESCRIPTION OF THE DRAWINGS

FIG. 1 is a diagram illustrating a spacecraft with electrical power source and interfaces according to embodiments of the present invention.

FIG. 2 illustrates an exemplary energy storage system according to embodiments of the present invention.

FIG. 3 illustrates another exemplary diagram of an energy storage system to provide power to a spacecraft according to embodiments of the present invention.

FIG. 4 is a flow chart illustrating one exemplary method for integration of an energy storage device according to embodiments of the present invention.

### DETAILED DESCRIPTION

The present disclosure may be understood by reference to the following detailed description taken in conjunction with the drawings as briefly described below. It is noted that, for purposes of illustrative clarity, certain elements in the drawings may not be drawn to scale.

Energy storage modules or Plug and Play (PnP) battery systems have been developed to extend shelf life such that the PnP battery systems are depot storable. These PnP battery systems are configurable to meet the SPA standard to satisfy all ORS requirements. The SPA Standard has been generated by the Department of the Air Force, Air Force Research Lab and managed by ORS. The SPA standard currently has one version, not finalized yet. The idea of the invention is to meet the SPA standard which may be revised later. A key to developing PnP battery systems fully capable of supporting all envisioned ORS needs is to overcome certain limitations in the traditional spacecraft batteries as previously discussed.

In the present art, there is a need for developing energy storage systems and methods that long shelf life. There also is need for energy storage systems and methods that provide an energy storage system with a short design lead-time. There further is a need for energy storage systems and methods that provide an energy storage system that needs less pre-launch maintenance. There is also a need for energy storage systems and methods that provide energy storage systems at low cost.

### Zero-Volt Cell

One aspect of the traditional spacecraft batteries is their limited cell life. Most existing cell technologies applicable to spacecraft systems use nickel-cadmium (Ni—Cd), nickel-metal hydride (Ni-MH), lead acid (Pb-acid), or lithium ion (Li-ion). Li-ion cells or other rechargeable cells possess limited shelf life after battery assembly and initial charge. Most new spacecraft utilize Li-ion cells because of their high energy density. However, conventional Li-ion batteries cannot survive a deep discharge to low voltages because battery performance may degrades both with time and whenever the cell voltage drops below approximately 2 volts per cell.

To prolong Li-ion battery life in customary spacecraft implementations, Li-ion cells typically are allowed to discharge to a cutoff voltage of 2.6 volts. Below or at such a cutoff voltage, a circuit for battery management cuts off the battery discharge. Unfortunately, during prolonged storage, a discharge below such a cutoff voltage level may be possible because of phenomena such as leakage currents in associated circuitry, calendar fade and self-discharge.

A Zero-Volt cell has extended shelf life. For example, Quallion has developed Li-Ion Zero-Volt cells. To mitigate the limitations of earlier Li-ion battery designs, Quallion has designed various cells, such as 15 ampere hour (Ah) and 72 Ah space satellite cells that can safely be discharged to zero volts at any time in its lifecycle, and stored for a prolonged period without performance degradation. For example, Zero-Volt cells retain, for example, 95% of capacity over a prolonged period of storage, such as one year, two years, or five years. Such cells with prolonged shelf life may be built into a battery for use in an energy storage module, according to embodiments of the present invention.

Another way of prolonging Li-ion battery life is to balance multiple cells to eliminate mismatches of series or parallel coupled cells, which improves battery efficiency and overall pack capacity.

Conventional rechargeable battery chemistries, such as Ni—Cd, Ni-MH and Pb-acid, operates using a dissolution-precipitation reaction where active material structures are disorganized and rebuilt during charge/discharge cycles. Li-ion chemistry has an insertion and dis-insertion chemistry, in which a host structure remains largely intact during a process of absorbing or releasing a guest material such as Li ions. Therefore, Li-ion chemistry may give long cycle life, a stable performance and is less prone to cell balance issues than the conventional rechargeable chemistries.

However, some factors can drive cells out of balance. One factor is that self-discharge rates of cells vary with temperature, and cells of a battery may operate at different temperatures for a variety of reasons including local self-heating effects. Another factor is that level of depth of discharge varies with temperature, and again temperature may vary across a battery. Additional factors include requirements of charge and discharge rates at different temperatures and a number of cycles at varying depth of discharge and temperatures.

For these reasons, it is important during battery design to ensure that all cells in a battery are exposed to similar environmental conditions. The stability of the Quallion's Zero-Volt cell may effectively reduce cell-balancing needs such that cell balance circuitry may not be needed for ORS tactical missions, which typically require at least one year of shelf life.

### Energy Storage System

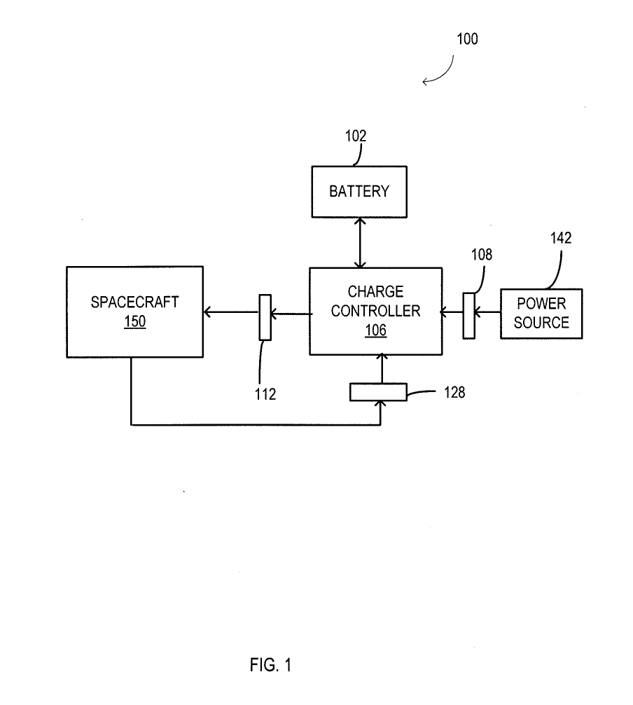

FIG. 1 is a diagram illustrating a system 100 including a spacecraft with power sources and interfaces. In system 100, a charge controller 106 receives an activation signal from spacecraft 150 through an activation interface 128 to provide electrical power to spacecraft 150. The activation signal may be triggered when a rocket separates from spacecraft 150 and then signals the system 100 through activation interface 128 to charge controller 106. Spacecraft 150 then receives electrical power from battery 102 under control of charge controller 106 through a power-out interface 112. An external power source 142 may provide power for charging battery 102 through power-in interface 108 if battery 102 does not have sufficient charge. If battery 102 has sufficient charge, charge controller 106 allows power output from battery 102 to spacecraft 150. If battery 102 does not have sufficient charge, controller 106 allows external power source to charge battery 102 to a sufficient level, and then allows power output from fully charged battery 102 to power spacecraft 150 through power-out interface 112. Power-out interface 112 is often referred to S/C main bus power interface.

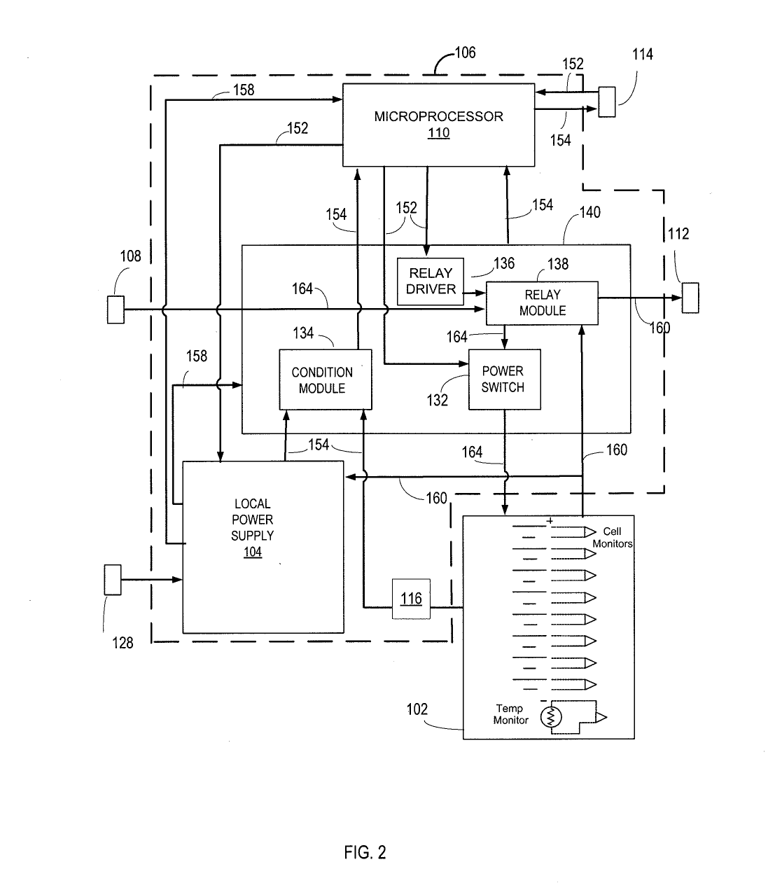

FIG. 2 is an detailed diagram of an exemplary energy storage system 200. System 200 includes a battery 102 and a charge controller 106. System 200 also includes a power-in interface 108 to an external power source 142 for inputting external power to charge battery 102. System 200 further includes a power-out interface 112 for outputting power to spacecraft 150 and a network interface 114 for communicating with spacecraft 150. System 200 also includes an activation interface 128 responsive to external signals to activate charging to battery 102 from external power source 142.

Charge controller 106 includes a microprocessor 110 with interface electronics, a power bus management module 140, and a local power supply 104. Power bus management module 140 includes a conditioning module 134 that collects status information of battery 102 and local power supply 104 and provides the status information to microprocessor 110, a relay module 138 that controls power output from battery 102 to spacecraft 150, and a power switch module 132 that controls charging of battery 102 from external power source 142. Power bus management module 140 also includes a relay driver 136 that transmits power to relay module 138.

Charge controller 106 may control charging of battery 102 from solar or other power from external power source 142. The solar or other power input through power-in interface 108 may be provided through relay module 138 and power switch module 132 to charge battery 102. External power source 142 may be a photovoltaic solar array in most spacecraft applications. Other power sources may be provided as well for charging battery 102.

According to embodiments of the present invention, provisions are made for self-startup and fault recovery in a Phoenix Mode, and initial activation by using local power supply 104. Local power supply 104 is a set of voltage regulators that receives power from battery 102, converts voltages, and provides power to all electronics including microprocessor 110, relay drive 136, relay module 138, conditioning module 134 and power switch module 132 in system 200.

Local power supply 104 is coupled to microprocessor 110 through control bus 152 and local power bus 158 to provide power to microprocessor 110. Power supply 104 also is adapted to receive command from microprocessor 110. Local power supply 104 is also coupled to battery 102 through battery power bus 160 to draw power from battery 102. Local power supply 104 is further coupled to power bus management module 140 for providing power to all the electronics in power bus management module 140. When local power supply 104 receives an activation signal from activation interface 128, local power supply 104 draws power from battery 102 through battery power bus 160. Local power supply 104 then turns on power to microprocessor 110 through local power bus 158. Microprocessor 110 also sends a command to local power supply 104 to turn on power for all electronics in power bus management module 140.

Battery 102 may output power to spacecraft 150 through battery power bus 160 to relay module 138 and then power-out interface 112. Battery 102 may be, among others, a Li-ion battery including Zero-Volt cells or any other battery that has a prolonged shelf life time and minimal performance degradation over a long period. The shelf life may be at least one year, or two years, three years, preferably five years. Various cell configurations in parallel or series may be used in building battery 102, and the cells may have different chemistry than Li-ion chemistry.

According to embodiments of the present invention, status of battery 102 may be monitored by microprocessor 110 in charge controller 106. For example, battery 102 is coupled to a status monitor 116 in charge controller 106. Status monitor 116 can measure voltage of each of individual cells in battery 102. The individual cells may be connected in series or parallel in battery 102. Status monitor 116 reports a level of charge of battery 102 to microprocessor 110 through conditioning module 134. When battery 102 has enough charge, charge controller 106 turns on main bus power to spacecraft 150 through power-out interface 112 to support normal spacecraft operation.

According to embodiments of the present invention, signal conditioning module 134 takes voltage, current and temperature sensor data from status monitor 116 coupled to battery 102 and other components (not shown) in charge controller 106, and scales the sensor data to standard engineering units (volts, amps, degrees C.). Scaled data are then directed to microprocessor 110 with interface electronics to allow communication with other SPA systems on spacecraft. Battery 102 may output power through power-out interface 112. Battery 102 reports on its capacity and level of charge via SPA standard, through a battery Extensible Transducer Electronics Data Sheet defined in advance. Conditioning module 134 is coupled to microprocessor 110, status monitor 116 and local power supply 104 through status bus 154.

According to embodiments of the present invention, power switch module 132 provides a switching function to battery 102. Power switch module 132 is coupled to microprocessor 110 through control bus 152. Power switch module 132 is also coupled to relay module 138 and battery 102 through solar array power bus 164. Power switch module 132 has a pulse width modulator. Power switch module 132 may be operated with a duty cycle ranging from 0% to 100%. Power switch module 132 controls solar or other power for charging battery 102 based upon the report to microprocessor 110 from status monitor 116 through conditioning module 134. Battery 102 includes a number of cells as shown in FIG. 2. If voltages of the cells are lower than a threshold, microprocessor 110 sends a command to power switch module 132 such that power switch module 132 can be turned on to allow charging of battery 102, with the solar or other power input through power-in interface 108. If the voltages of the cells are above the threshold, power switch module 132 can be turned off so that battery 102 does not receive further charge. Microprocessor 110 controls power switch module 132 based upon the report from status monitor 116.

According to embodiments of the present invention, relay module 138 allows power from power-in interface 108 through power switching module 132 to battery 102 to allow battery charging if status monitor 116 indicates that battery 102 is not adequately charged. Relay module 138 also allow power output from battery 102 to spacecraft 150 through power-out interface 112 if battery 102 is adequately charged. Relay module 138 is coupled to power-in interface 108 or solar array power interface 108, the power-out interface 112 or main bus power interface 112. Relay module 138 is also coupled to battery 102 through battery power bus 160, relay driver 136 through control bus 152, and power switch module 132 through solar array power bus 164. If a report to microprocessor 110 from status monitor 116 through conditioning module 134 indicates that voltages of the cells are high enough or above a threshold, microprocessor 110 sends a command to relay module 138 through relay driver 136, allowing battery 102 to output power through power-out interface 112. If the report to microprocessor 110 from status monitor 116 via conditioning module 134 indicates that the voltages of the cells are below the threshold, microprocessor 110 sends a command to power switch module 132 to allow charging of battery 102 by inputting the external power through power-in interface 108 and a command to relay module 138 to shut down power output to spacecraft 150 through power-out interface 112.

According to embodiments of the present invention, in the Phoenix Mode, when an anomaly on spacecraft 150 results discharging of battery 102 below an energy level required to maintain normal spacecraft operation, relay module 138 switches off power output to power-out interface 112 through power switch module 132. Meanwhile, local power supply 104 maintains operation of microprocessor 110, which configures relay module 136 to transmit external power through power-in interface 108 to charge battery 102 to recover adequate level of charge. Relay driver 136 transmits power to control the relays in relay module 138.

According to embodiments of the present invention, microprocessor 110 is coupled to conditioning module 134 through status bus 154, power bus management module 140 through status bus 154 and network interface 114. Microprocessor 110 can collect the status information of all components including battery 102, local power supply 104 and power bus management module 140 through status bus 154 and report to spacecraft 150 through network interface 114. Microprocessor 110 is also coupled to control charge controller 106 components including relay driver 136, power switch module 132 and local power supply 104 through control bus 152, as well as network interface 114. Microprocessor 110 can receive commands from the spacecraft through network interface and send command to those components in charge controller 106.

Microprocessor 140 incorporates a programmable firmware. Such a firmware allows flexibility to provide batteries with any desired configurations, such as cell voltage, battery voltage, charge management, total energy storage, and peak current capabilities.

In a typical operation, system 200 receives a command signal from the rest of spacecraft 150 through activation interface 128. The command signal indicates that spacecraft 150 has separated from a launch vehicle. The command signal turns on local power supply 104, which gets input power directly from battery 102. Local power supply 104 activates all electronics in power bus management electronics 140, then activates microprocessor 110 with interface electronics by turning on its local power. Microprocessor 110 examines the level of charging of battery 102 through status monitor 116. Signals from status monitor 116 are calibrated in signal conditioning module 134. If the level of charge is sufficient, power bus management electronics 140 turns on main bus power to spacecraft 150 through relay module 138 and power-out interface 112. If the level of charging is not sufficient, system 200 enters a “Phoenix Mode”, in which relay module 132 is supplies power to battery 102 from external power source 142, while the main bus power to spacecraft 150 is off. Once battery 102 is adequately charged, microprocessor 110 changes the state of relay module 132 to turn on the main bus power to spacecraft 150 through power-out interface 112.

Microprocessor 110 communicates to the rest of spacecraft 150 through network interface 114. Network interface 114 may allow communication with a Power Management and Distribution system that includes power management firmware running on a separate spacecraft power-management processor. Spacecraft 150 may send command to microprocessor 110 through network interface 114 to reconfigure the operation of system 200 for various needs. Microprocessor 110 incorporates firmware responsible for charging and maintaining battery 102. The firmware during normal spacecraft operation seeks to maintain an adequate battery charge by regulating the amount of power from external power source 142 into battery 102 through power switching module 132.

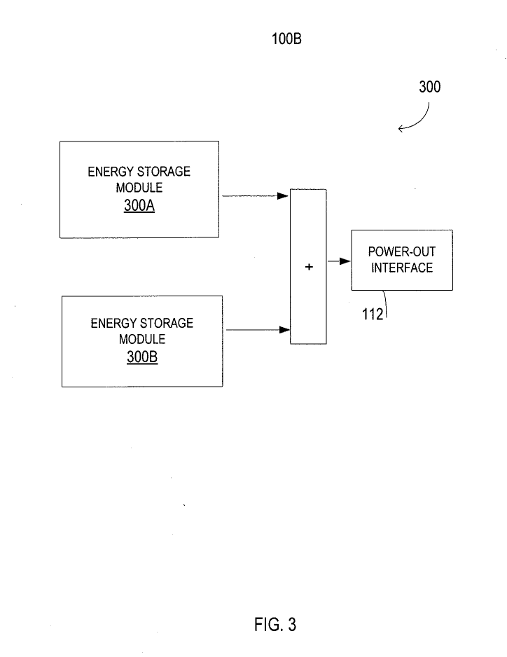

The available output current through power-out interface 112 may be increased by connecting two PnP modules in parallel. FIG. 3 illustrates an exemplary diagram of two energy storage systems for providing power output to an interface to spacecraft 150. System 300 includes a first energy storage system 300A and a second energy storage system 300B. The output currents from energy storage systems 300A and 300B are added and then output to power-out interface 112. Each of the two energy storage systems 300A and 300B may be like energy storage system 200 without power-out interface 112, as illustrated in FIG. 2.

### Integration of PnP Battery System

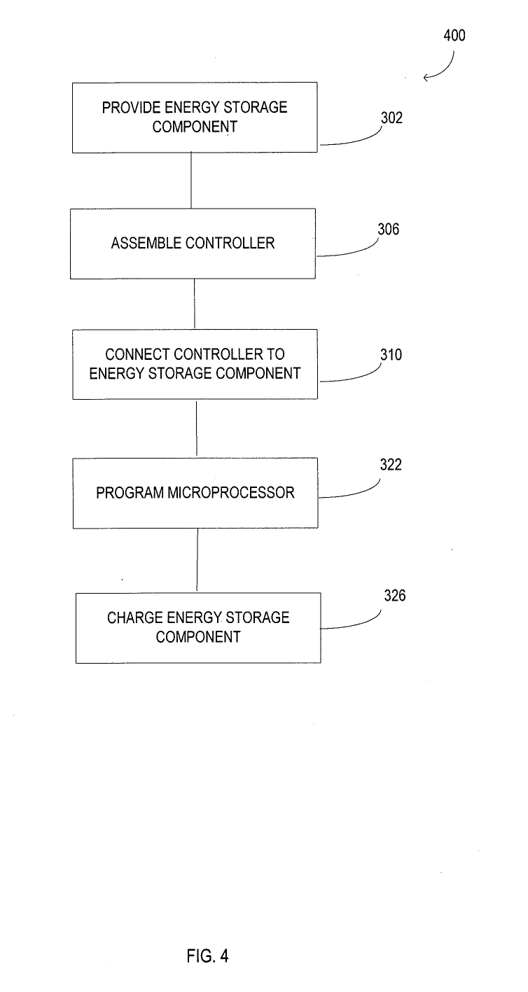

FIG. 4 is a flow chart illustrating one exemplary method 400 for integration of an energy storage device. Method 400 starts with providing an energy storage component that has a minimum shelf life time at step 302, where the energy storage component is uncharged. The minimum shelf life of the energy storage component is at least one year, and preferably, five years.

Method 400 continues with assembling a charge controller and a multiple interfaces with the energy storage component at step 306, for example, from off the shelf components. The charge controller includes a microprocessor with interface electronics, a local power supply, and a power bus management electronics module. The interfaces include a network interface that conforms to SPA standard. The interfaces also include a power-in interface to receive an input power from an external power for charging the energy storage component. The interfaces further include a power-out interface for outputting power from the energy storage component. The plurality of interfaces includes an interface for receiving an activation signal from an external source. Method 400 also includes programming the microprocessor for the energy storage component at step 322 and charging the energy storage component from the external power source at step 326.

According to embodiments of the present invention, energy storage stsytems or PnP Battery systems are built to have the same configuration of interfaces, regardless of cell chemistry or capacity. A firmware is programmed into charge controller 106. The firmware has tables specific to a particular configuration and allows the charge controller to be configured for to accommodate a range of system voltages, battery chemistries, and rated energy capacities. PnP battery systems incorporate cells that may be assembled by using a partibular Li-ion battery technology, such that the PnP battery systems can be built up in advance of anticipated need and stored on shelf for a prolonged time without degradation in battery performance. Charge controller 106 may monitor the cells after the battery systems have been initially charged and put into use.

Network interface 114 may be a SPA standard communication interface, according to embodiments of the present invention. The SPA standard communication interface allows immediate plug-in compatibility of the finished PnP battery system into a SPA-based PnP spacecraft. The SPA standard communication interface also allows applications within the data-centric network to query for data with specific characteristics, subscribe to suitable matches, and manage multiple instances of data to facilitate fault tolerance and robustness.

The incorporation of a charge control firmware into charge controller 106 eliminates the need for development of customized firmware to perform charge management. The use of common charge control electronics in charge controller 106 eliminates the need for time consuming hardware design. Thus, a PnP battery system can be constructed from standard components and programmed with the general charge control firmware within days of obtaining the cells. When requested at any time, a PnP battery system can be pulled off the shelf at an avionics depot. The PnP battery system may be initially charged and installed on a particular spacecraft so that the PnP battery system may be tested and fully integrated into the spacecraft in hours. Such integration would eliminate long time required for battery development and its integration into the spacecraft in traditional technologies.

One of the benefits of the ESM or PnP battery system is that it has a standard off the shelf configuration, rather than a custom build configuration. The PnP battery system meets the needs of different missions by allowing multiple ESM-Battery units to be integrated onto a single spacecraft as specified. Additionally, the ESM design is robust enough to support several different configurations of Zero-Volt cells without changing hardware, but only changing a charge control firmware. Thus, the PnP battery system may be integrated for depot-shelf availability by using electronics design. Use of cells having prolonged shelf life time allows completing PnP battery systems much faster than use of traditional cells. In addition, the PnP battery system may be stockpiled for years in advance of anticipated need.

Another benefit of the ESM is that it has SPA compliance, which enables network-based and data centric spacecraft system management. SPA compliance also provides necessary configuration flexibility to support the “six day” satellite integration that is a core goal of ORS tactical mission capability. The incorporation of standard interfaces and SPA communication protocols (xTEDS) means that the time typically required to design mission-specific interfaces can also be significantly shortened.

An additional benefit of the ESM or PnP battery system is a potential reduction in cost associated with cell balancing, customized program for energy management and customerized hardware for building the energy storage module in traditional energy storage devices.

While the above is a description of specific embodiments of the present device and method, various modifications, variations and alternatives may be employed. Moreover, other techniques for varying the chemistry of the cells could be employed. Other external power sources could be employed. Examples of the possible variations include, but are not limited to, cell chemistry and cell voltages for PnP battery systems, and the like. Examples of possible variations also include changing the sequence of steps in integration of the energy storage system from the sequence shown in FIG. 4.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An energy storage device comprising:
an energy storage component including a plurality of cells, each cell having a minimum shelf life;
a first interface to an external power source configured for charging of the energy storage component;
a second interface to a spacecraft for outputting power from the energy storage component;
a third interface for communicating to spacecraft; and
a charge controller operatively coupled with the energy storage component and the first, second and third interface, wherein:
the charge controller comprises an internal power supply configured to provide power for the charge controller, and
the charge controller comprises a microprocessor incorporating a firmware to accommodate a system configuration of the energy storage component.

2. The energy storage device of claim 1, wherein the charge controller comprises a conditioning module operatively coupled to the energy storage component, the internal power supply, and the microprocessor.

3. The energy storage device of claim 1, wherein the charge controller comprises a relay module operatively coupled to the first and second interface and the energy storage component.

4. The energy storage device of claim 3, wherein the relay module is coupled to the internal power supply.

5. The energy storage device of claim 3, wherein the charge controller comprises a relay driver operatively coupled to the microprocessor and the relay module.

6. The energy storage device of claim 5, wherein the relay driver is coupled to the internal power supply.

7. The energy storage device of claim 3, wherein the charge controller comprises a power switching module operatively coupled to the energy storage component, the microprocessor, and the relay module.

8. The energy storage device of claim 7, wherein the power switching module is coupled to the internal power supply.

9. The energy storage device of claim 1, wherein the internal power supply is responsive to an activation signal from an external signal source through a fourth interface.

10. The energy storage device of claim 1, wherein the internal power supply is operatively coupled to the microprocessor and the energy storage component.

11. The energy storage device of claim 9, wherein the external signal source comprises a spacecraft.

12. The energy storage device of claim 1, wherein each of the plurality of cells comprises a Zero-Volt cell.

13. The energy storage device of claim 1, wherein the minimum shelf life of each of the plurality of cells is at least one year.

14. The energy storage device of claim 1, wherein the minimum shelf life of each of the plurality of cells is at least five years.

15. The energy storage device of claim 1, further comprising a plurality of energy storage components, each of the plurality of energy storage components comprising a plurality of cells that have a minimum shelf life of at least one year.

16. The energy storage device of claim 15, wherein the plurality of energy storage components are connected in parallel.

17. The energy storage device of claim 1, wherein the third interface conforms to the Space Plug and Play Avionics network standard.

18. An energy storage device comprising:
an energy storage component including a plurality of cells, each cell having a minimum shelf life;
a first interface to an external power source configured for charging of the energy storage component;
a second interface to a spacecraft for outputting power from the energy storage component;
a third interface for communicating to spacecraft; and
a charge controller operatively coupled with the energy storage component and the first, second and third interface, wherein:
the charge controller comprises an internal power supply configured to provide power for the charge controller,
the charge controller comprises a microprocessor incorporating
a firmware to accommodate a system configuration of the energy storage component;
the charge controller comprises a relay module operatively coupled to the first and second interface and the energy storage component, and
the charge controller comprises a power switching module operatively coupled to the energy storage component, the microprocessor, and the relay module.

19. The energy storage device of claim 18, wherein each of the plurality of cells comprises a Zero-Volt cell.

20. The energy storage device of claim 18, wherein the third interface conforms to the Space Plug and Play Avionics network standard.
